(19) United States
(12) Patent Application Publication
(10) Pub. No.: US 2011/0037577 A1
(43) Pub. Date: Feb. 17, 2011

(54) REMOTE-CONTROLLED VEHICLE GEAR STICK LOCKING DEVICE

(76) Inventor: PEI-CHENG CHIU, Kaohsiung City (TW)

Correspondence Address: LEONG C. LEI, PMB # 1008, 1839 YGNACIO VALLEY ROAD, WALNUT CREEK, CA, 94598, US

(21) Appl. No.: 12/539,596

(22) Filed: Aug. 11, 2009

(51) Int. Cl. B60R 25/10

(52) U.S. Cl. 340/426.1

(57) ABSTRACT

A remote-controlled vehicle gear stick locking device includes a gear stick lock and a control host. The gear stick lock is driven by a power unit that is controlled by the control host to carry out locking and unlocking operations. The control host is coupled to an alarm host of a theft alarm device built in the vehicle. Thus, the original function of a remote control emitter of a vehicle theft alarm device for setting and releasing release various anti-theft alarming equipments of the vehicle is preserved, while the remote control emitter of the vehicle theft alarm device can also be used in remote control of locking and unlocking operations of the gear stick lock, so as to upgrade the performance of the gear stick lock for improving operability and security for anti-theft of the vehicle.

### TECHNICAL FIELD OF THE INVENTION

The present invention generally relates to a remote-controlled vehicle gear stick locking device, and more particularly to a remote-controlled vehicle gear stick locking device that is controlled by a remote control emitter that is ordinarily used to control a vehicle theft alarm system built in the vehicle, so as to improve the operation thereof.

### DESCRIPTION OF THE PRIOR ART

Most automobiles, when shipped to the dealers, are additionally equipped with a theft alarm device 1. As shown in FIG. 1, the theft alarm device 1 generally comprises a remote control emitter 11 and an alarm host device 12 installed in an automobile. The remote control emitter 11 is carried by an owner of the automobile, while the alarm host device 12 that is installed in the automobile is coupled to a central door lock 121, an ignition system 122, a fuel supply system 123, and a sound/lighting (headlights and horns) alarm system 124 of the automobile, so that when the automobile owner, within an effective receiving distance of the alarm host device 12, activates the remote control emitter 11 to disarm various anti-theft alarm instructions, the alarm host device 12 outputs a signal by which the central door lock 121 of the automobile is unlocked, the sound/lighting alarm system 124 is actuated to operate by giving off an alarm of sound or lighting, for example flashing the automobile signal lights several times and making the horn or buzzer to give off short sounding, and the ignition system 122 and the fuel supply system 123 are put in normal standby conditions. The automobile owner may then open a door to get in the automobile and insert a key in the ignition switch to start up the engine. On the other hand, when arriving at a destination, the automobile owner leaves the automobile and activates the remote control emitter 11 again to issue a locking instruction, whereby the alarm host device 12 outputs a signal again, which sets the ignition system 122 and the fuel supply system 123 in fuel-off and power-off conditions and locks the central door lock 121. And, the automobile is set in an alarm armed condition.

To enhance the effectiveness of anti-theft alarming, most of the vehicle manufacturers or mot of the general consumers may add a gear stick locking device to the automobile. When the owner arms or disarms of the theft alarm device with various anti-theft instructions by using the remote control emitter 11, additional manual operation is needed for effecting locking of the gear stick locking device. To unlock, a key of the gear stick locking device must be operated to release the gear stick locking device. Thus, both locking operation and unlocking operation of the locking device cannot be operated simultaneously with and by the remote control emitter. This is troublesome and often prevents the vehicle owner from willingly using the gear stick locking device when he or she intends to leave the vehicle, or leads to the inconvenience that the vehicle owner may forget to unlock the gear stick locking device before he or she starts the engine.

In view of the above discussed drawbacks and inconveniences, it is desired to improve the anti-theft alarming function of an anti-theft alarm device that is built in an automobile in a simplest and safest manner without causing any damage to any parts of the automobile so as to provide operation convenience to the automobile owner.

### SUMMARY OF THE INVENTION

A primary objective of the present invention is to provide a remote-controlled vehicle gear stick locking device, which comprises a power unit that is driven by a power drive system to operate a gear stick lock for carrying out locking and unlocking operations. The operating unit is controlled by a control host, which is coupled to an alarm host of an anti-theft alarm device that is installed in a vehicle. The control host comprises a CPU (Central Processing Unit) based automatic control circuit, which is coupled to a power supply and voltage regulation system and a power drive system. In this way, the original function of a remote control emitter of a vehicle built-in anti-theft alarm device for setting and releasing release various anti-theft alarming equipments of the vehicle is preserved and the remote control emitter of the vehicle built-in anti-theft alarm device can also be used in remote control of locking and unlocking operations of a vehicle gear stick lock, so as to upgrade the performance of the vehicle gear stick lock for improving operability and security for anti-theft of the vehicle.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a conventional vehicle alarm system.

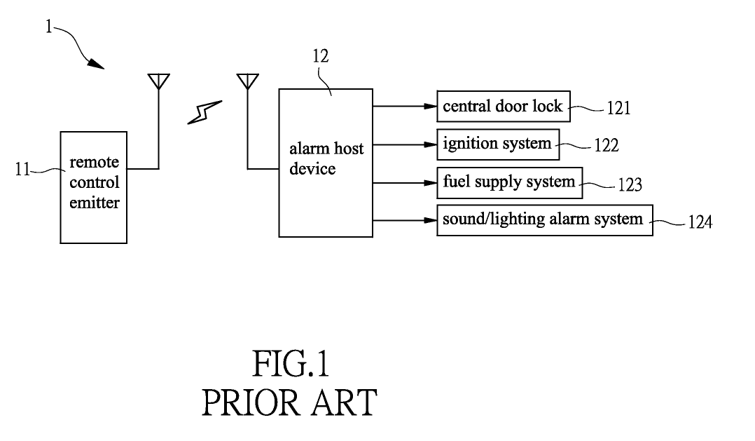

FIG. 2 is a block diagram of a control host of a vehicle alarm system of the present invention.

FIG. 3 is a block diagram showing the control host and a gear stick locking device of an embodiment of the present.

FIG. 4 is a block diagram showing another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

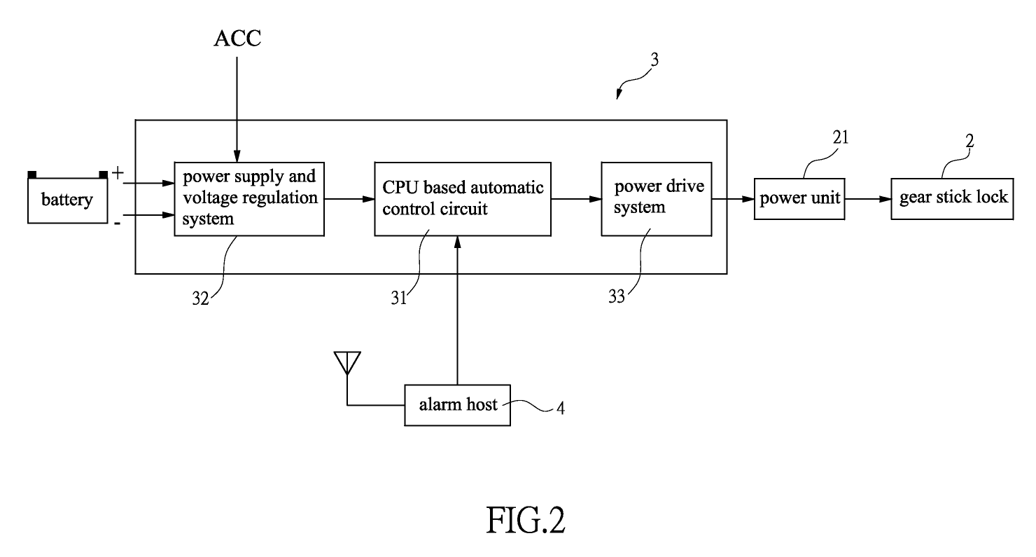

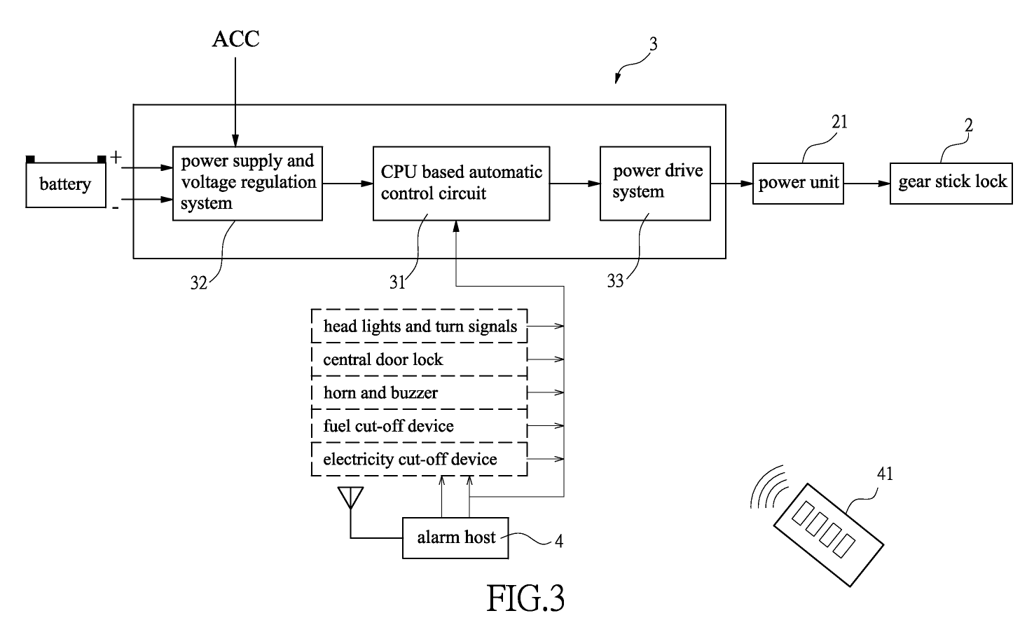

As shown in FIGS. 2 and 3, a vehicle gear stick locking device in accordance with the present invention comprises a gear stick lock 2 and a control host 3. The gear stick lock 2 is operable by a power unit 21, whereby the operating unit 21 drives locking and unlocking operations of the gear stick lock 2. The control host 3 comprises a CPU (Central Processing Unit) based automatic control circuit 31. The CPU based automatic control circuit 31 is connected to a power supply and voltage regulation system 32 and a power drive system 33. The control host 3 is also coupled to an alarm host 4 of a theft alarm device that is built in a vehicle.

The CPU based automatic control circuit 31 is designed to connect to the alarm host 4 of the theft alarm device built in the vehicle and may detect a signal output from the alarm host 4.

The power supply and voltage regulation system 32 is connected to a built-in power source of the vehicle, such as a vehicle battery or other spare power supplies.

The power drive system 33 comprises a power supply output system and the power drive system 33 is operable in response to receiving a power output signal.

In the practice of the present invention, as shown in FIG. 3, the control host 3 is connected to the power unit 21 of the gear stick lock 2 of the vehicle. In practice, the power unit 21 may comprise a control of a driving motor or a solenoid. The control host 3 is connected through the CPU based automatic control circuit 31 thereof to the alarm host 4 of the theft alarm device built in the vehicle to detect the output signal of the alarm host 4.

When an owner of the vehicle leaves the vehicle and attempts to set anti-theft equipments of the vehicle through the remote control emitter 41 of the theft alarm device of the vehicle within an effective range, the alarm host 4 of the theft alarm device built in the vehicle carries out the setting operations of the anti-theft equipments in accordance with a signal that is originally set or set in factory for the purposes. Then, the alarm host 4 supplies an output signal that is transmitted to the CPU based automatic control circuit 31 of the control host 3. When the CPU based automatic control circuit 31 detects and confirms the correctness of the output signal from the alarm host 4, the CPU based automatic control circuit 31 issues an instruction that activates the operation of the power drive system 33, which in turn moves the power unit 21 to drive locking operation of the gear stick lock 2.

On the other hand, the vehicle owner, when attempting to enter and drive the vehicle, operates the remote control emitter 41 within the effective range to release the anti-theft equipments, the alarm host 4 that mates the remote control emitter 41 carries out the releasing operations of the anti-theft equipments in accordance with a signal that is originally set or set in factory for the purposes. Then the alarm host 4 supplies an output signal to the CPU based automatic control circuit 31 of the control host 3 of the present invention. When the CPU based automatic control circuit 31 detects and confirms the correctness of the output signal from the alarm host 4, the CPU based automatic control circuit 31 issues an instruction that activates the operation of the power drive system 33, which in turn moves the power unit 21 again to drive unlocking operation of the gear stick lock 2.

Besides detecting the output signals from the alarm host 4, the CPU based automatic control circuit 31 of the present invention may be designed to simultaneously detect a signal of setting and releasing operation of an anti-theft equipment of the vehicle that is driven by the alarm host 4, such as the signals of setting and releasing operation of the vehicle anti-theft equipment including central door lock, head lights and turn signals, horn, buzzer, fuel cut-off device, and electricity cut-off device.

With this arrangement, when the remote control emitter 41 of the theft alarm device is operated to set or release the anti-theft equipments, the CPU based automatic control circuit 31 of the present invention detects not only the output signal from the alarm host 4, but also the signal of setting and releasing operations of an anti-theft equipment that is driven by the alarm host 4. Multiple checking is done by detection the signal of the alarm host 4 and the signal of setting (releasing) operation of the anti-theft equipment before the CPU based automatic control circuit 31 issues the instruction to activate the operation of the power drive system 33 that in turn moves the power unit 21 to lock and unlock the gear stick lock 2. In this way, fault decision made by the CPU based automatic control circuit 31 may be eliminated or alleviated. Further, in practice, the CPU based automatic control circuit 31 of the present invention can be design to not only detect the output signal from the alarm host 4, but also the signals of setting and releasing operations of two or more than two anti-theft equipments of the vehicle and then an instruction is issued to activate the operation of the power drive system 33 so as to ensure the correctness of operation of the power drive system 33 and reduce the chance of fault operation.

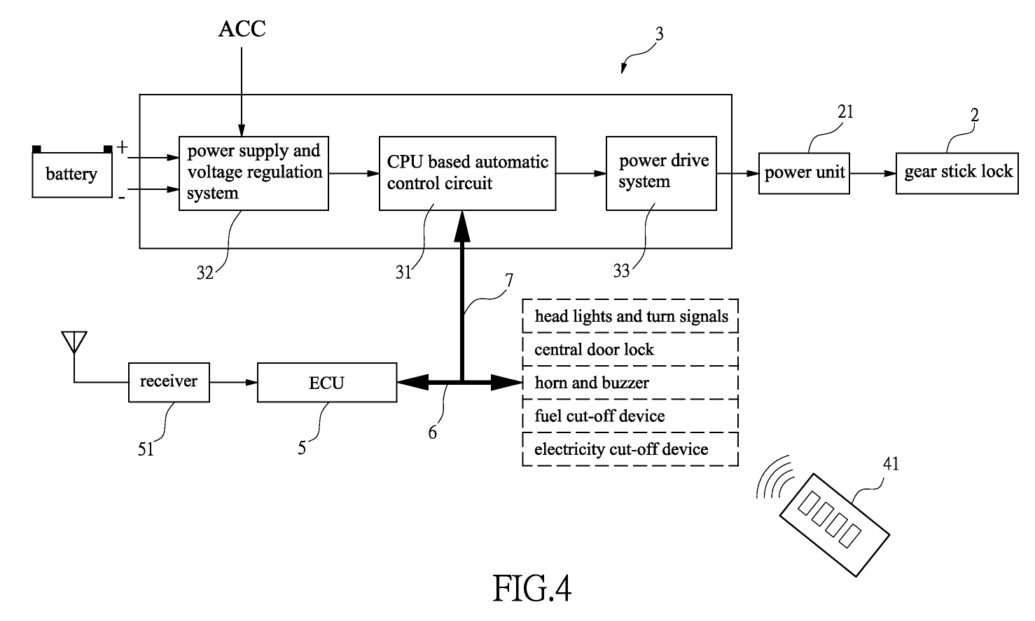

Further, as shown in FIG. 4, some vehicles that are currently available in the market may carry an electronic control unit (ECU) 5. The ECU 5 comprises a receiver 51 that receives an instruction signal from the remote control emitter 41. The ECU 5 may carry out setting operations of various anti-theft equipments of the vehicle, including central door lock, head lights and turn signals, horn and buzzer, and fuel and electricity cut-off devices, through a transmission network 6. The transmission network 6 may comprise a controller area network bus (CAN Bus), a local interconnect network (LIN) bus, or a combination of both CAN bus and LIN bus, built in the vehicle.

In this respect, the CPU based automatic control circuit 31 of the control host 3 may comprise a signal transmission line 7 connected to the transmission network 6. The signal transmission line 7 intercepts and receives instruction signals transmitted through the transmission network 6 and applies the instruction signals to the CPU based automatic control circuit 31. The CPU based automatic control circuit 31 of the present invention may be designed to identify the instructions that are issued from the ECU 5 for setting and releasing of the anti-theft equipments.

As such, when the remote control emitter 41 is operated to issue a radio signal to carry out setting or releasing of various anti-theft equipments of the vehicle, the receiver 51 passes the instruction to the ECU 5 and the ECU 5 transmits the instruction of setting or releasing through the transmission network 6 to the anti-theft equipments to carry out associated operation. Thus, the CPU based automatic control circuit 31 of the present invention may comprise the signal transmission line 7 connected to the transmission network 6 so that when the transmission network 6 is transmitting an instruction signal from the ECU 5, the signal transmission line 7 may intercept and receive the instruction signal and passes the instruction signal to the CPU based automatic control circuit 31 to allow the CPU based automatic control circuit 31 to determine if the instruction signal is to set or release the anti-theft equipments. Once the instruction signal is determined to be a signal for setting and releasing the anti-theft equipments, the CPU based automatic control circuit 31 controls the power drive system 33 to issue a corresponding instruction signal to the power unit 21 so that the power unit 21 carries out locking and unlocking operation of the gear stick lock 2.

In other words, when a signal acquired from the transmission network 6 by the CPU based automatic control circuit 31 of the present invention acquires, through the signal transmission line 7, is identified to be an instruction signal to set the anti-theft equipments, the CPU based automatic control circuit 31 controls the power drive system 33 to issues an instruction signal to the power unit 21, which is then activated to supply power to carry out locking operation of the gear stick lock 2 to thereby complete the operation of locking the gear stick lock 2. On the other hand, when a signal acquired from the transmission network 6 by the CPU based automatic control circuit 31 of the present invention acquires, through the signal transmission line 7, is identified to be an instruction signal to release the anti-theft equipments, the CPU based automatic control circuit 31 controls the power drive system 33 to issues an instruction signal to the power unit 21, which is then activated to supply power to carry out unlocking operation of the gear stick lock 2 to thereby complete the operation of unlocking the gear stick lock 2.

The efficacy of the present invention is that when the remote control emitter 41 of a vehicle is operated to set or release the anti-theft equipments of the vehicle, the control host 3 of the present invention also outputs a signal to make the power unit 21 of the gear stick lock 2 to operate in a forward sense or in a backward sense so that the gear stick lock 2 may follow the setting and releasing operations of the anti-theft equipments to carry out locking and unlocking operations and thus locking and unlocking of the gear stick lock 2 can be effected through remote control, so that the performance of the vehicle gear stick lock may be upgraded for improving operability and security for anti-theft of the vehicle.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A remote-controlled vehicle gear stick locking device, comprising:
a gear stick lock, which is selectively driven by a power unit to carry out locking or unlocking operation; and
a control host, which comprises at least a CPU based automatic control circuit, which is connected to a power supply and voltage regulation system and a power drive system and is adapted to couple to an alarm host of a theft alarm device built in a vehicle;
wherein the CPU based automatic control circuit of the control host detects a signal output from the alarm host of the theft alarm device so that when the alarm host performs a setting or releasing operation of a anti-theft equipment of the vehicle, the CPU based automatic control circuit of the control host detects the signal output from the alarm host and the control host issues a signal that makes the power unit coupled thereto operating in a forward sense or a backward sense to have the gear stick lock locked or unlocked simultaneously with the setting or releasing operation of the anti-theft equipment.

2. The remote-controlled vehicle gear stick locking device according to claim 1, wherein the CPU based automatic control circuit detects a signal of setting or releasing operation of two or more than two anti-theft equipments controlled by the alarm host of the theft alarm device of the vehicle before the CPU based automatic control circuit issues an instruction to activate the power drive system to supply power output in order to ensure correct operation of the power drive system and reduce the chance of fault operation.

3. The remote-controlled vehicle gear stick locking device according to claim 1, wherein the power unit comprises a drive motor.

4. The remote-controlled vehicle gear stick locking device according to claim 1, wherein the power unit comprises a solenoid.

5. A remote-controlled vehicle gear stick locking device, comprising:
a gear stick lock, which is selectively driven by a power unit to carry out locking or unlocking operation; and
a control host, which comprises at least a CPU based automatic control circuit, which is connected to a power supply and voltage regulation system, a power drive system and a signal transmission line;
wherein the signal transmission line of the CPU based automatic control circuit of the control host is connected to a transmission network of an electronic control unit built in the vehicle to intercept and receive an instruction signal transmitted through the transmission network and applies the instruction signal so intercepted to the CPU based automatic control circuit, so that the CPU based automatic control circuit identifies the instruction signal as an instruction signal to set or release an anti-theft equipment of the vehicle and the CPU based automatic control circuit controls the power drive system to supply a corresponding instruction signal to the power unit to carry out locking or unlocking operation of the gear stick lock.

6. The remote-controlled vehicle gear stick locking device according to claim 5, wherein the transmission network of the electronic control unit comprises a controller area network bus.

7. The remote-controlled vehicle gear stick locking device according to claim 5, wherein the transmission network of the electronic control unit comprises a local interconnect network bus.

8. The remote-controlled vehicle gear stick locking device according to claim 5, wherein the transmission network of the electronic control unit comprises both controller area network bus and local interconnect network bus.

9. The remote-controlled vehicle gear stick locking device according to claim 5, wherein the power unit comprises a drive motor.

10. The remote-controlled vehicle gear stick locking device according to claim 1, wherein the power unit comprises a solenoid.
